(19) United States
(12) Patent Application Publication
(10) Pub. No.: US 2002/0146168 A1
(43) Pub. Date: Oct. 10, 2002

(54) Anchor shot detection method for a news video browsing system

(75) Inventors: Ji Eun Lee, Seoul (KR); So Young Bae, Gyunggi-do (KR); Kyoung Ro Yoon, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/102,896

(22) Filed: Mar. 22, 2002

(30) Foreign Application Priority Data
Mar. 23, 2001 (KR) 15270/2001

(51) Int. Cl. G06K 9/00

(52) U.S. Cl. 382/165; 382/170

(57) ABSTRACT

The present invention relates to a method for automatically detecting anchor shot in news video contents.

The present invention comprises steps of extracting the anchor shot candidates in news video divided by unit of shot, clustering similar shots among the extracted anchor shot candidates, and deciding an anchor shot by selecting a cluster of the anchor shot among the clusters which the similar shots are grouped.

Also, in accordance with the present invention, anchor shot candidates is extracted on the basis of motion information, color variance, length of shot, face detection information, and ratio of not-coded macroblock, similar shots are clustered based on the color similarity of the extracted anchor shot candidates, and the genuine anchor shot are decided by selecting the cluster of anchor shot among the clusters on the basis of the number of shots belonging to the cluster, the existence ratio of article subject character, and the existence ratio of news icon.

### BACKGROUNG OF THE INVNETION

1. Field of the Invention

The present invention relates to a content-based multimedia searching and browsing system, and more particularly to a method for effectively summarizing and browsing news video by automatically detecting an anchor shot in which an anchor (a news master) appears in news video.

2. Description of the Related Art

With the recent developments of digital video technique and image/video/audio recognition technique, users become capable of searching, filtering, and browsing only desired portions of specific multimedia contents at a desired time.

The most fundamental skills for non-linear multimedia content browsing and searching are a shot segmentation and a shot clustering techniques. Also, these two techniques are essential means for structurally analyzing multimedia contents.

In video arts, the shot means a sequence of video frames acquired by one camera without interruption, and is a basic unit for video analysis and construction.

Further, in general, there exists a scene of construction element in video, where the scene is a meaningful discriminatory element in story development or a video construction, and there are several numbers of shots in one scene. These concepts of shot and scene can be applied to an audio program in the same way as that of the video program.

Ultimately, a multimedia content indexing scheme performs index of structural information for multimedia content by extracting the structural information by unit of shot or scene that exists in contents and then extracting primary characteristics such as key frames which can represent the segment for each of structural units.

Also, the multimedia content indexing scheme performs indexing in such a way that describes meaningful information with respect to an occurrence of event, appearance of audio-visual objects, a state of object, background (whereabouts), etc along time axis. As a result, the users are enabled to easily browse or search the desired portions.

Generally, in multimedia content, news video streams correspond to a fixed pattern of spatial-temporal structured model of a video data. Unlike from general multimedia streams, news video streams are formalized/structured video data, one of which is composed of several articles and one article is composed of a summary description part by news anchor and an episode part supporting the article contents. The general news comprises all of the related articles such as politics, economy, society, sports and weather and the news video has a typical pattern of structure different from the other genre of video contents. Furthermore, it is apparent that the users have different interested fields one another. Therefore, the request for rapidly searching really desired news articles is the more escalated then ever.

In order to accommodate the request for rapidly searching really desired news articles in a video indexing aspect, the related research is continually being conducted for indexing news video streams in unit of article by utilizing the structural/meaningful information of news video. In addition, a non-linear news video browsing scheme is being researched which couples news video data indexed on the basis of article unit by utilizing the time structure of news video with interfaces such as Table of Content (TOC) or Storyboard.

As described above, news is fairly structured video data, and so one news video stream is composed of several articles and one article is composed of an introductory portion of the anchor and a data display.

Article-based news browsing method is that of browsing news in article unit. If a proper user interfaces is prepared, the users can comprehend entire articles included in news video at one sight and selectively view desired articles only.

FIG. 1 shows an example of the above article-based news browsing method.

One of conventional techniques of extracting an anchor shot for news browsing utilizes characteristics of an anchor shot. For example, there is a method of extracting the anchor shot by utilizing the characteristics that the extraction of face area is possible, the motion is small, the background is uniform, and the length of shot is usually long.

For another example, there is a method of deciding which cluster is that of the anchor shot by utilizing face detection information, spatial structure information of the anchor shot, etc. after clustering the shots whose temporal color variance of color information and motion information is small based on a color histogram.

For another example, there is a method of deciding the anchor shot in terms of speaker on the basis of the speaker recognition technique.

However, the conventional anchor shot detection techniques described above could not adequately reflect the characteristics of anchor shots which enable users to distinguish the anchor shot from the other reporter shots or interview shots, etc. For example, in case of the anchor shot, news icon and the subject article character appear in addition to the face of anchor. Therefore, it is difficult to detect the genuine anchor shot in as much as to simply detect the anchor shot based on several information which are considered in the conventional anchor shot detection technique described above, and also the credibility of detection result is not high. Therefore, it is very difficult to obtain desired results if conducting article-based browsing of news video by utilizing these conventional techniques.

### SUMMAMRY OF THE INVENTION

Therefore, the present invention is directed to an effective method for detecting an anchor shot from news article in an article-based news browsing system that substantially obviates one or more problems due to limitations and disadvantages of the related art.

It is an object of the present invention to provide a method for automatically detecting an anchor shot of a news article that enables various and effective article-based browsing of news video.

It is another object of the present invention to provide more reliable method for correctly detecting a genuine anchor shot from a news article.

To achieve the above objects and other advantages and in accordance with the purpose of the present invention, as embodied and broadly described herein, there is provided an anchor shot detection method in the news video browsing system comprising steps of: extracting anchor shot candidates for detecting an anchor shot in news video divided by unit of shot, clustering similar shots among the extracted anchor shot candidates, and deciding an anchor shot by selecting a cluster of the anchor shot among the clusters which similar shots are grouped.

To achieve the above objects and other advantages and in accordance with the purpose of the present invention, as embodied and broadly described herein, there is also provided an anchor shot detection method in news video browsing system comprising steps of extracting anchor shot candidates by utilizing motion information, color variance, length of shot, face detection information, or ratio of not-coded macroblock of moving picture compressed by utilizing motion compensation compressing method, etc. of news video divided by unit of shot, acquiring anchor shot candidates by clustering similar shot based on the color similarity of the extracted anchor shot candidates, and deciding the genuine anchor shot by selecting the cluster of anchor shot among the clusters on the basis of the number of shots belonging to the cluster, the existence ratio of article subject character, the existence ratio of news icon.

Also, the automatic anchor shot detection method in news video browsing system according to the present invention comprises extracting anchor shot candidates in news video divided by unit of shot, clustering the extracted anchor shot candidates, and deciding genuine anchor shots by selecting the cluster of anchor shot among the clusters.

Also, the automatic anchor shot detection method in news video browsing system according to the present invention is characterized in that the method utilizes motion information, color variance, length of shot, face detection information, or the ratio of not-coded macroblock of moving picture compressed by utilizing motion compensation compressing method as decision standards for extracting the anchor shot candidates.

Also, the automatic anchor shot detection method in news video browsing system according to the present invention is characterized in that the method utilizes color similarity between shots for clustering said similar anchor shot candidates.

Also, the automatic anchor shot detection method in news video browsing system according to the present invention is characterized in that the method utilizes the number of shots belonging to cluster, the existence ratio of article subject characters, and the existence ratio of news icon when selecting the cluster of anchor shot among the clusters.

### BRIEF DESCRIPTION OF THE DRAWINGS

The above and other objects, features and other advantages of the present invention will be more clearly understood from the following detailed description and appended claims, taken in conjunction with the accompanying drawings. Understanding that these drawings depict only typical embodiments of the invention and are, therefore not to be considered limiting of its scope, the invention will be described with additional specificity and detail through use of the accompanying drawings, in which:

FIG. 1 illustrates an example of an article-based browsing of news video,

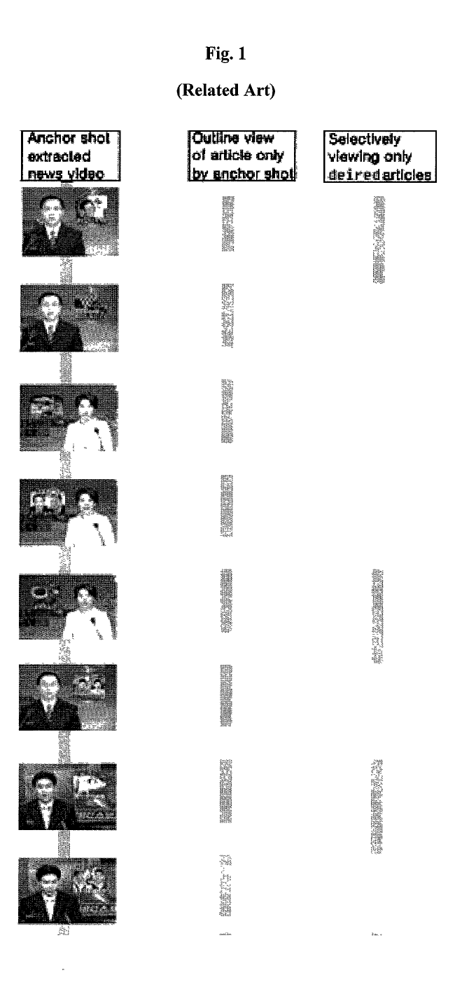

FIG. 2 is a flow chart of anchor shot detecting method according to the present invention,

FIG. 3 illustrates anchor shot candidate according to the present invention,

FIG. 4 is a drawing for describing clustering of anchor shot candidate according to the present invention,

FIG. 5 illustrates the result of clustering among the anchor shot candidate according to the present invention, and

FIG. 6 illustrates the construction of anchor shot according to the present invention.

### DETAILED DESCRIPTION OF THE INVENTOIN

The following detailed description of the embodiments of the invention is not intended to limit the scope of the invention, as claimed, but is merely representative of the presently preferred embodiments of the invention. In the description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

An anchor shot is defined as a part in which an anchor appears to describe contents of articles. Generally, there are two main anchors of male and female in main streams of the news, and there can be a sports anchor who introduces sports news at the end of the news.

The present invention considers the sports anchor appearing part as well as the main anchor appearing part to be a shot.

Particularly, detecting an anchor shot in news video divided in a unit of shot is conducted by three steps according to the present invention.

Step 1. Extracting anchor shot candidates.

Step 2. Clustering among the anchor shot candidates.

Step 3. Selection of cluster and Decision of an anchor shot

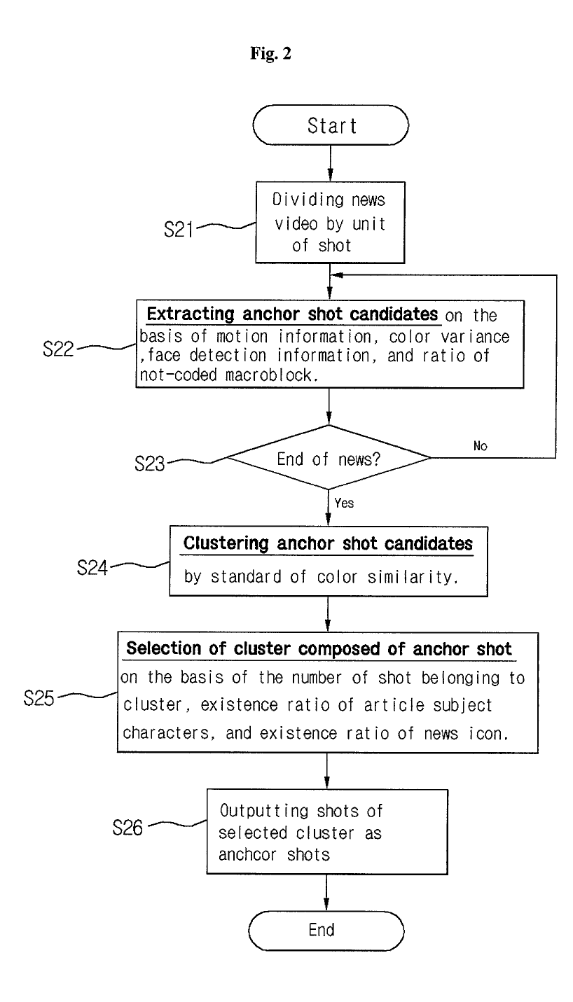

FIG. 2 is a flow chart representing a process of the anchor shot detection according to the present invention. With reference to FIG. 2, the detecting step of the anchor shot according to the present invention is shown.

First, in order to detect anchor shots, news video must be divided by unit of shot (S21).

With respect to all shots of news video divided by unit of shot, the anchor shot candidates are extracted on the basis of decision standards such as motion information, color variance, length of shot, face detection information, ratio of not-coded macroblock, etc(S22).

At the next step, it is decided whether or not this is the end of the news (S23). If this is the end of the news, this step continues to the next step of clustering anchor shot candidates (S24). However, if this is not the end of the news, this step returns to the previous step of extracting anchor shot candidates (S22).

After anchor shot candidate extracting is performed with respect to entire news video, the anchor shot candidates are clustered on the basis of color similarity (S24).

Then, a cluster composed of the anchor shots is selected on the basis of decision standards such as the number of shots belonging to the cluster, existence ratio of article subject characters, or existence ratio of news icon (S25). Thereafter, shots of the selected cluster are decided to be anchor shots and outputted (S26).

Here, the processes from S21 to S26 steps must be performed for all shots of news video divided by unit of shot.

The anchor shot detection method according to the present invention comprises three steps of anchor shot candidates extracting step, clustering among the anchor shot candidates, and anchor shot decision.

This method is described in more detail as follows:

1. Extracting anchor shot candidates

Anchor shot candidates are extracted for each shot of the news video divided by unit of shot on the basis of motion information, color variance, length of shot, face detection information, and ratio of not-coded macroblock. The decision standards for identifying anchor shot candidates are explained below.

(1) Motion information

Because an anchor shot presents a little motions, the standard that amount of motions is below a predetermined critical value can be applied.

Here, the motion information is acquired by utilizing motion vector in case of news video of moving picture compressed by motion compensation compression method (MPEG-1/2, H.261, H.263, etc).

(2) Color variance

Because an anchor shot exhibits no meaningful changes in color, the standard that the color variance is below a predetermined critical value can be applied. That is, color information of each frame is defined by a color histogram. Then, a color difference is calculated by comparing color histograms between frames. If the color variance of the shot is below the critical value, the shot can be an anchor shot candidate.

At this time, deciding the color variance of shot can be performed by sampling any number of frames in one shot and calculating the color variance between extracted sample frames. Afterward, it is decided whether or not to recommend it as an anchor shot candidate. This sampling scheme shortens the extracting time for anchor shot candidates.

(3) Length of shot

An anchor shot has a peculiar characteristic that the lasting time is long. Almost all of anchor shots have a length of 5 to 10 seconds, while a sports article has a shorter lasting time such as 2 seconds. Therefore, if the length of shot is longer than a predetermined critical value in comparison, the shot is recommended to be an anchor shot candidate.

(4) Face detection information

By definition itself, anchor shot is a scene that face of anchor must be shown. Therefore, the face must be detected in the frames of anchor shot, a size of face is below one predetermined critical value as well as above the other predetermined critical value, and the direction of face should be oriented to the front direction. These standards can be applied because the anchor should appear in constant position with constant size in camera viewing angle.

Therefore, if the anchor's face is detected and the size of the face ranges between the upper and lower levels, the shot is recommended to be an anchor shot candidate.

(5) Ratio of not-coded macroblock

The anchor shot comprises composite images such as news icon (the representative scene displayed in small picture adjacent to the anchor to express implicitly the meaning of news article described by the anchor), or characters of article subject.

As a result, when the news article is a moving picture compressed by utilizing motion compensation compressing method such as MPEG-1/2, H.261, H.263, the standard that the ratio of not-coded macroblock is above a predetermined minimum critical value can be applied, and also another standard that the ratio is below another predetermined maximum critical value can be applied because the ratio of not-coded macroblock is low in case that the whole frames are composite images.

Therefore, it is possible to define the upper and lower critical values for the ratio of not-coded macroblock, and if the ratio is within the range, the anchor shot is recommended to be an anchor shot candidate.

By the above process, an anchor shot candidate is extracted by applying the decision standards such as motion information, color variance, length of shot, face detection information, ratio of not-coded macroblock. Also, the decision of an anchor shot candidate can be made more accurate by applying at least one decision standard and allocating a weight to each decision standard when applying multiple decision standards.

For example, if the anchor changes a posture or walks along in anchor shots of less patterned news (e.g., news tracking or history special), the standards of motion information and color variance are weakened, thereby differentiation with other shots can be lowered. In this case, the weights for motion information and color variance can be lowered preferably.

Also, if the length of anchor shots is longer than other shots as to enhance differentiability, the weight for shot length can be higher.

By this way, the capability for extracting anchor shot candidates can be enhanced by raising the weights for the characteristics having high differentiability such as motion information, color variance, length of shot or face detection information and lowering the weights for the characteristics having low differentiability.

The anchor shot candidates extracted by applying the above decision standards are of main anchor shots of male/female, anchor shots of sports section, interview shots, reporter shots, etc.

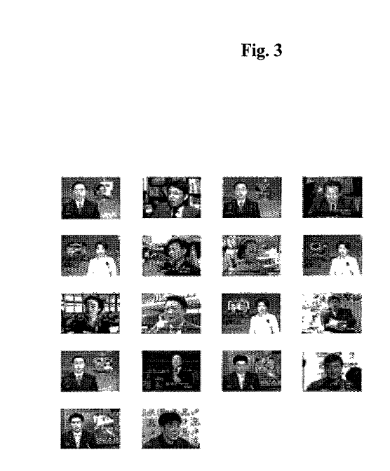

FIG. 3 shows examples of anchor shot candidates extracted by applying these decision standards. Particularly, FIG. 3 shows examples that male anchor shots, female anchor shots, sports section anchor shots, interview shots, and reporter shots are extracted as anchor shot candidates.

2. Clustering among the anchor shot candidates

After extracting anchor shot candidates, clustering among the anchor shot candidates is performed such that similar shots among the extracted anchor shot candidates is grouped. The basis for grouping is suggested as follows.

(1) Color similarity: Color histograms of frames within the shots or sampled frames of shots for each anchor shot candidate is acquired as representative color information. Then, shots having similar color information are grouped by comparing these values (Grouping).

The color information of shot is defined to be a mean color histogram of frames in shots, or otherwise defined to be a mean color histogram of sampled frames in shots.

Then, color similarity can be acquired by calculating the difference between said mean color histograms. Of course, for this case, after comparing the color similarity between shots to a predetermined critical value, only anchor shot candidates having the color similarity above the critical value are clustered.

The reason why anchor shot candidates should be grouped is explained below.

The color information is not totally identical even for the anchor shots. The color difference exists for anchor shots because of face color, head color, cloth color, and background color which are dependent upon male/female main anchor and a sports section anchor. The color difference exists even for the same anchor's shots because of the differences of news icon or characters of article subject which depend on news article described by the anchor.

Therefore, the upper and lower critical values for color similarity are so defined as to group similar shots such that same anchor's shots are grouped together whereas different anchor's shots are not grouped together.

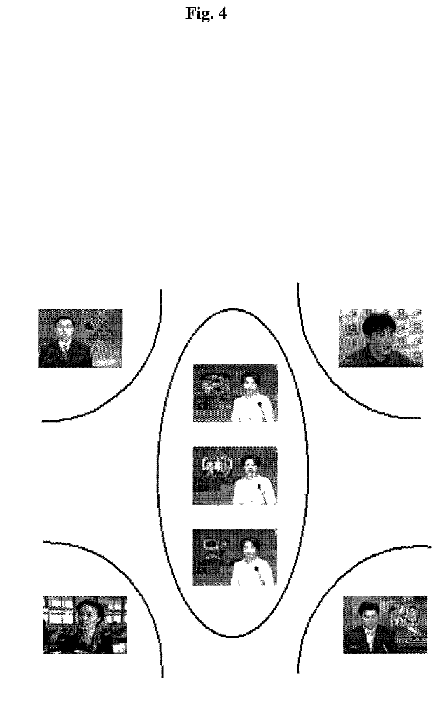

FIG. 4 shows the clustering of anchor shot candidates.

In FIG. 4, the standard for color similarity is shown. In the present invention, the color similarity can be considered to be color difference vice versa, and so the concept of color difference can be thought to be an extension of color similarity. That is, the higher the color similarity, the smaller the color difference, and vice versa. By utilizing these properties similar shots can be grouped.

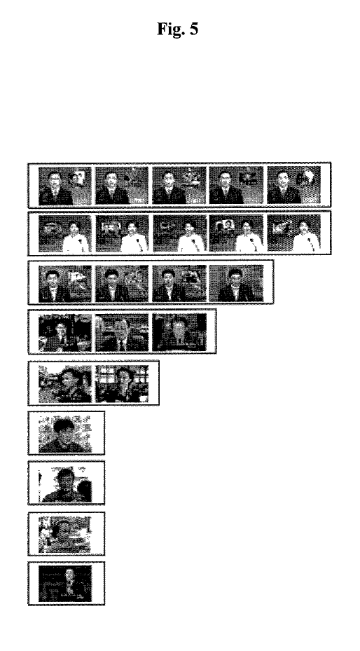

In this way, if clustering among the anchor shot candidates is conducted by utilizing color similarity, each of male anchor shot, female anchor shot, and sports section anchor shot is clustered respectively in one group as shown by Fig.5. However, because interview shots or reporter shots do not have such a high color similarity, it is not easy for them to be grouped with anchor shot, as well as grouping among the interview shots or reporter shots are not easy.

That is, as shown by FIG. 5, because genuine anchor shots usually have a fixed pattern of display composition, they can be easily grouped. However, the color similarity of interview shots or reporter shots is not so much high because such shots are usually developed diversely and dynamically based upon circumstances. Therefore the grouping reporter shots or interview shots with anchor shots is very difficult as well as grouping with another reporter shots or interview shots is not easy.

3. Anchor shot decision by cluster selection

The anchor shot is finally selected among the anchor shot candidates grouped by clustering among the said anchor shot candidates. That is, by selecting the cluster composed of anchor shots among the clustered anchor shot candidates, anchor shots of news video are decided. The standards for selecting cluster are described below.

(1) The number of shot belonging to a cluster: Main anchor shots and sports anchor shots should appear frequently in number above certain critical values for one news video. Because the anchor is a master who progresses the corresponding news, this master appears at the front of article introduction part as many times as to explain the news article. Therefore, main anchor shots and sports anchor shots should appear in the number above certain critical value for one news video. For example, usually for one hour news, each of male and female main anchors appear respectively above 10 times, and the sports section anchor appears above 5 times. Therefore, a standard is established that if the number of shots belonging to the group is below a predetermined critical value, the group is not selected, but the group is selected if the number of shots belonging to the group is above the critical value. In general, unnecessary groups can be removed by this standard because interview shots or reporter shots are not grouped in many shots (usually one or two shots).

(2) Existence ratio of article subject characters: Generally, news icon and article subject co-appear in anchor shot even though in some cases only anchor appears to introduce the article without news icon or subject characters.

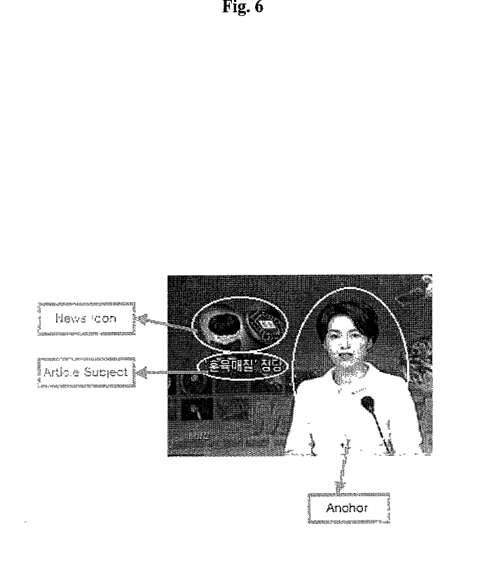

FIG. 6 shows the construction of general anchor shot. With reference to FIG.6, anchor, news icon, and article subject appear simultaneously in the anchor shot.

Therefore, for all shots of one cluster, the existence ratio of article subject characters is considered to be decision standards for genuine anchor shot.

For an anchor shot group, the existence ratio of article subject characters is very high (generally, it is expected that 8 to 9 among the 10 anchor shots have article subject characters), while for groups other than the anchor shots, the existence ratio of article subject characters is very low. Therefore, if the existence ratio of article subject characters is above a predetermined critical value, this group can be considered as a cluster of anchor shots.

(3) Existence ratio of news icon: The news icon existence ratio can be used as a selection standard for a cluster. As shown in FIG. 6, the probability that news icon appears in an anchor shot is very high. Therefore, once we decide whether or not news icon exists for all shots of one cluster and then acquire the ratio of shot in which news icon exists, the existence ratio of news icon will be high for anchor shots, while the existence ratio of news icon will be low for groups other than anchor shots.

Generally, it is experimentally known that 8 to 9 shots among the 10 anchor shots have a news icon. Therefore, if the existence ratio of news icon in one cluster is above a predetermined critical value, the cluster is decided to be an anchor shot cluster or a cluster composed of anchor shots, and otherwise it is not a cluster composed of anchor shots.

Therefore, the anchor shot decision step by cluster selection can be made more accurately by applying at least one decision standard among the said anchor shot decision standards and allocating a weight to each of the decision standards when applying several decision standards.

For example, the weighting value for existence ratio of news icon can be set to zero in order not to apply this standard for news in which news icon does not appear.

Also, in applying the standards of the number of shots belonging to the cluster, the existence ratio of article subject characters, and etc., the weight of the decision standards can be differently allocated by raising the weights for the characteristics having high differentiability and lowering the weights for the characteristics having low differentiability.

In this way, all shots in the cluster that are finally selected through the anchor shot cluster decision standards are decided to be anchor shots. The anchor shot detecting method according to the present invention is completed thereby.

As described above, because the present invention automatically detects anchor shots of news video, the news can be divided in a unit of article on the basis of an anchor shot.

Also, because the news video is divided in a unit of article on the basis of an anchor shot, article-based news browsing is enabled.

Also, because the users are enabled to summarize the entire contents of news at one sight of the key frames of anchor shot, or selectively view the desired articles among the total news articles, or view in short only anchor shots of the article content summarized by anchor, various and effective article based news browsing can be enabled.

Particularly, because the anchor shots can be classified into a particular category clearly differentiated from other reporter shots or interview shots by the present invention, the credibility and accuracy of the anchor shot that detection as well as detection of genuine anchor shot can be guaranteed overcoming simple detection of anchor shot based on a few information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An automatic anchor shot detection method for news video browsing system, comprising the steps of:
extracting anchor shot candidates for detecting anchor shots in news video divided by unit of shot;
clustering similar shots among the extracted anchor shot candidates; and
deciding the anchor shots by selecting a cluster of the anchor shots among the clusters which the similar shots are grouped.

2. The method of claim 1, wherein at least one decision standard is applied to each of the extracting step, the clustering step, and the deciding step, and the method adaptively deals with changes of news progressing composition or type of news progressing composition by allocating a predetermined weight to each of the decision standards.

3. The method of claim 1, wherein at least one of motion information, color variance, length of shot, face detection information, and ratio of not-coded macroblock of moving picture compressed by utilizing motion compensation compressing method is applied as a standard for deciding anchor shot candidates in extracting the anchor shot candidates.

4. The method of claim 1, several decision standards among motion information, color variance, length of shot, face detection information, the ratio of not-coded macroblock of moving picture compressed by utilizing motion compensation compressing method are applied to decide anchor shot candidates, while predetermined weights are allocated to all the several decision standards in extracting the anchor shot candidates.

5. The method of claim 1, wherein clustering of the anchor shot candidates is performed on the basis of color similarity between the shots.

6. The method of claim 1, wherein deciding the anchor shots by selecting a cluster of the anchor shots is performed by applying at least one decision standard among the number of shots belonging to the cluster, existence ratio of article subject characters, and existence ratio of news icon.

7. The method of claim 1, wherein deciding the anchor shots by selecting a cluster of the anchor shots is performed by applying several decision standards among the number of shots belonging to the cluster, existence ratio of article subject characters, and existence ratio of news icon, while predetermined weights are allocated to the several decision standards.

8. The automatic anchor shot detection method in news video browsing system comprises the steps of:
extracting anchor shot candidates in news video divided by unit of shot on the basis of at least one decision standard among motion information, color variance, length of shot, face detection information, or ratio of not-coded macroblock of moving picture compressed by utilizing motion compensation compressing method;
clustering the extracted anchor shot candidates on the basis of color similarity between the shots; and
deciding the anchor shots among the clusters which grouped by the clustering on the basis of at least one decision standard among the number of shots belonging to the cluster, existence ratio of article subject characters, and existence ratio of news icon.

9. The method of claim 8, wherein extracting anchor shot candidates is performed by selecting the anchor shot candidates according to the results of comparing each of motion information, color variance, length of shot, face detection information, and ratio of not-coded macroblock to each of predetermined critical values or predetermined critical ranges prescribed for each of the decision standards, wherein the predetermined critical values and ranges are defined as maximum and minimum threshold.

10. The method of claim 8, wherein the motion information can be acquired by utilizing motion vector in case of moving pictures compressed by motion compensation compressing method.

11. The method of claim 8, wherein the color variance means variance degree of colors between frames.

12. The method of claim 8, wherein color information of each frame is defined by a color histogram and the color information is acquired by applying color difference between color histograms of the frames, when applying the color variance as a decision standard for extracting anchor shot candidates.

13. The method of claim 8, wherein the color variance between frames can be acquired by sampling any number of frames in one shot and calculating the color difference between extracted sample frames, when applying the color variance as a decision standard for extracting anchor shot candidates.

14. The method of claim 8, wherein a size of face and a direction of face are the decision basis for anchor shot candidates, when the face detection information is applied as a decision standard for extracting anchor shot candidates.

15. The method of claim 8, wherein a size of face is set within a predetermined critical range such that the size ranges between upper and lower critical values of the predetermined critical range, when the face detection information is applied as a decision standard for extracting anchor shot candidates.

16. The method of claim 8, wherein, if not-coded macroblock of a moving picture compressed by utilizing motion compensation compressing method is applied as a decision standard for extracting anchor shot candidates, a decision standard that ratio of not-coded macroblock is above a predetermined minimum critical value can be applied, and also another standard that the ratio of not-coded macroblock is below another predetermined maximum critical value can be applied because the ratio of not-coded macroblock is low in case that whole frames are composite images.

17. The method of claim 8, wherein color information for acquiring similarity between each shot is defined by a mean color histogram of frames within the shots, or by a mean color histogram of sample frames extracted in the shots.

18. The method of claim 8, wherein clustering of the extracted anchor shot candidates is conducted in accordance with the results of comparing color similarity between the shots to a predetermined critical value.

19. The method of claim 8, wherein the color similarity between the shots is acquired by calculating the difference between mean color histograms of the shots.

20. The method of claim 8, wherein the anchor shot cluster is decided in accordance with the results of comparing each of the decision standards of the number of shots belonging to the cluster, existence ratio of article subject characters, and existence ratio of news icon to each of predetermined critical values prescribed for each of the decision standards, when deciding the anchor shots.
